(19) United States
(12) Patent Application Publication
(10) Pub. No.: US 2009/0119875 A1
(43) Pub. Date: May 14, 2009

(54) Damping device group for furniture hinges

(76) Inventor: Carlo Migli, Lecco LC (IT)

Correspondence Address: JACOBSON HOLMAN PLLC, 400 SEVENTH STREET N.W., SUITE 600, WASHINGTON, DC, 20004, US

(21) Appl. No.: 12/289,939

(22) Filed: Nov. 7, 2008

(30) Foreign Application Priority Data
Nov. 14, 2007 (IT) MI2007A 002169

(51) Int. Cl. E05D 7/00

(52) U.S. Cl. 16/233

(57) ABSTRACT

A damping device group is intended to be mounted on an articulated hinge for pieces of furniture and comprising a base plate, integral with or to be fixed onto flanges of the hinge holding member. Present on the base are two pivoted levers which move towards each other to compress a transverse damping device when a slider is moved rearwards towards the damping device due to the thrust of the wing which enters into the compartment of the holding member. Advantageously, the group reproduces the C-shape of the holding member with its flanges and it has a minimum overall dimension.

### BACKGROUND OF THE INVENTION

1. Field of the Invention

The present invention refers to a damping device group for furniture hinges, integral with or to be fixed onto the hinge holding member.

2. State of the Prior Art

In the technique of hinges for pieces of furniture, well known are the articulated hinges of the type comprising a fixed part, called wing, intended to be fixed onto the side of the holding container, and a moveable part or holding member intended to be recessed into the door. Wing and holding member are connected to each other by means of a joint which allows the relative movement of the two components. Comprised in the joint is a spring which completes the closure and opening movement, making the two positions stable.

Proposed in the prior art have been various solutions to provide such type of hinge with a damping device. However, it is desired that the system modifies the shape and the size of a traditional hinge least possible. Furthermore, from a commercial point of view it is also desirable to have a damping device group both separate and capable of allowing a removable fixing on a standard articulated hinge: as a matter of fact, in this case, the damping device can be sold as an accessory in such a manner not to weigh directly on the cost of the finished furnishing element.

It is also desirable that the system be inexpensive and of low complexity. Low complexity is also linked to the reliability of the system.

However, most of the solutions proposed up to date require that the hinge be specifically made to integrate the damping device group, or such solutions are subject to other disadvantages and thus unsatisfactory.

The simplest solution for providing a hinge with a damping device is that of mounting the damping device on the wing, aligned parallel with the wing itself. As a matter of fact, the elongated shape of the wing is particularly suitable to accommodate—at the upper part—a linear damping device, which is usually cylindrical-shaped having a length similar to that of the wing and which thus operates directly in the approaching direction of wing and holding member to push against the holding member during closure.

Above all, in cases requiring an independent system, such solution however suffers two major drawbacks. First and foremost, the wing is usually made with various shapes depending on the field of application of the hinge: emblematic is the case of different covers of the door on the side, such doors being obtained with wings having different curvatures or necks, or the case of doors with tilted abutments, like the ones used in end pieces of furniture with doors tilted by 30° or 45°. In these cases, the wings also come in very different shapes and, thus, also the accessory used to fix the damping device, in such a manner to operate properly against the surface of the box, must consequently be of a different shape and type of fixing. Furthermore, the accessory bearing the damping device covers the access to the fixing and adjustment systems which are located along the axis of the hinge wing. Therefore, in order to adjust the door properly it is required that the damping device be removed and reinserted into place only upon completion of all the adjustment operations.

EP 1404938 describes damping devices mounted on a hinge wing.

In order to solve the aforementioned problems proposed were damping devices fixed on the hinge holding member. As a matter of fact, the holding member is made in compliance with the strictest standards thus the same holding member is usually used on different hinges of the same series. Furthermore, it is relatively easy to identify a common surface on the various wings having different necks or abutment inclinations in such a manner that the damping device fixed against the holding member can react correctly against the wing. The damping device and its fixing system can thus be only one for the entire series of hinges. Furthermore, usually the holding member does not have adjustment systems thus the fixing of the damping device accessory can be performed only once, with minimum probabilities of having to be removed over the entire lifespan of the hinge.

However, the fixing against the box has a serious drawback: should one want to operate the damping device directly on the wing it is required that the axis of the damping device be aligned with that of the extension of the wing. Thus the damping device projects from the holding member in a direction opposite to the wing thus generating a considerable overall dimension which significantly deteriorates the aesthetic properties of the hinge and which, in case of doors with a frame, it can lead to the complete inapplicability of the hinge in question. As a matter of fact, in such case the structure of the door is made up of a perimetral framework made of wood or metal and which bears, therein, a panel with a smaller thickness and which can be represented by a glass or mirror. The accessory bearing the damping device can thus project in an absolutely unwanted manner.

The already abovementioned EP 1404938 also describes damping devices mounted on the holding member but which extend in an unwanted manner for an elevated extension behind the holding member itself.

Also WO 2005/088052 describes a damping device mounted on the holding member, but which still extends at the rear part thereof with an unwanted overall dimension.

U.S. Pat. No. 3,975,791 describes a damping device mounted on the holding member and extended in the thrust direction of the wing. In order to maintain the extension short, a very short damping spring is proposed, but leading to a poor action of the damping device in such manner.

In order to reduce the overall dimension of the damping device group it was proposed to arrange the damping device in a transverse direction with respect to the axis of the hinge using a kinematism which converts the relative motion of the wing with respect to the holding member, such operation occurring in a plane perpendicular to the rotation axis of the door, in a movement in the direction of the axis of the hinge.

WO 2006/088435 describes a damping device group mounted on the holding member and which extends above the holding member in a transverse manner with respect to the movement direction of the wing. A cam device is arranged centrally between two thrust springs, in such a manner that the rotation of the cam, caused by the impact with the wing thrust in closure, symmetrically compresses the springs. Thus the damping device is of the rotating type. The necessity of having a rotating cam and short but sufficiently strong thrust springs, leads to an unwanted increase in the projection of the device above the holding member. Furthermore, use of short thrust springs substantially reduces the efficiency of the damping effect and make the device relatively fragile.

WO 2007/038815 describes various kinematisms for compressing a suitable damping device fixed in a transverse manner on the holding member. For example, proposed is the use of two bell crack levers on the holding member to project with one of its ends thereinto. When the hinge closes the part of the wing that enters into the holding member pushes on such ends raising from the plane of the holding member the other ends of the levers, arranged among which is the damping device element. However, the movement of the levers is transverse to the extension of the damping device element and hence the action of the levers is disadvantageous. Thus, not only is the kinematism fragile, but also scarcely efficient and, in any case, it leads to an increase of the projection of the mechanism above the plane of the door. Still in WO 2007/038815 proposed is the use of a tension member arranged in the holding member and which is tensioned by the part of the wing that enters thereinto during closure. The height of the device above the holding member is thus reduced, but the solution is scarcely efficient and easily subject to jamming or breaking.

Another solution described in WO 2007/038815 comprises a holding member specially made with a pair of bell crack levers symmetrically arranged on the holding member to provide a pliers-shaped element which operates on the two ends of the damping device element through some other short retraction levers. The central pivoting of the pliers-shaped element is pin-connected to a central slider which enters into the holding member to form an actuation end on which the part of the hinge-wing which enters into the holding member, operates. The mechanism thus obtained is relatively expensive and complex. Furthermore, the mechanism extends at the rear part of the holding member with the moveable parts changing in terms of overall dimensions depending on the conditions of the hinge. Other mechanisms shown in WO 2007/038815 and based on similar principles all reveal serious drawbacks, thus being undesirable. For example, use of lever manoeuvre ends, on which the wing is required to slide, complicates the coupling. On the other hand, rotating cam systems are scarcely efficient and they are fragile due to the necessarily limited diameter of the cam. Such kinematisms also often imply having an additional extension at the rear part of the holding member.

A general object of the present invention is to overcome the abovementioned drawbacks providing an innovative damping device group for furniture hinges which though being intended to be mounted or integrated on the holding member, is, among other advantages, simple, inexpensive, extremely efficient and having a small overall dimension.

### SUMMARY OF THE INVENTION

Considering such object, according to the invention, conceived was a damping device group intended to be mounted on an articulated hinge for pieces of furniture, comprising: a base plate, integral with or to be fixed onto flanges of the holding member of the hinge, shaped to have lateral zones intended to be arranged on the two sides of the holding member, with a main axis of the plate substantially coinciding with the extension axis of the hinge; two levers each shaped and pivoted on one of said two lateral zones, according to a axis normal to the plate thus extending parallel to the surface of the plate and perfectly symmetrical with respect to said main axis of the plate, the levers ending at the opposite side with respect to the pivoting with facing ends operating on opposite ends of a linear travel damping device arranged in a transverse manner with respect to the main axis of the plate; a slider mounted in a sliding manner on the plate between the two levers to project with one of its actuation surfaces from an edge of the plate arranged between the said two lateral zones, the slider being extended in a transverse manner with respect to said main axis, sliding according to the said main axis and having sliding engagements at the two sides at the levers to slide on tilted surfaces opposite to the two levers in such a manner to pull the levers towards each other and compress the damping device therewith when the slider is pushed towards the damping device.

### BRIEF DESCRIPTION OF THE DRAWINGS

For a better explanation of the innovative principles and advantages of the present invention with respect to the prior art described hereinafter, with the help of the attached drawings, is a possible example of an embodiment applying such principles. In the drawings:

FIG. 1 represents a perspective and exploded schematic view of a damping device group according to the invention;

FIG. 2 represents a bottom view of a cover element of the group of FIG. 1;

FIG. 3 represents a view of the group of FIG. 1 applied to the holding member of an articulated hinge.

### DETAILED DESCRIPTION OF THE INVENTION

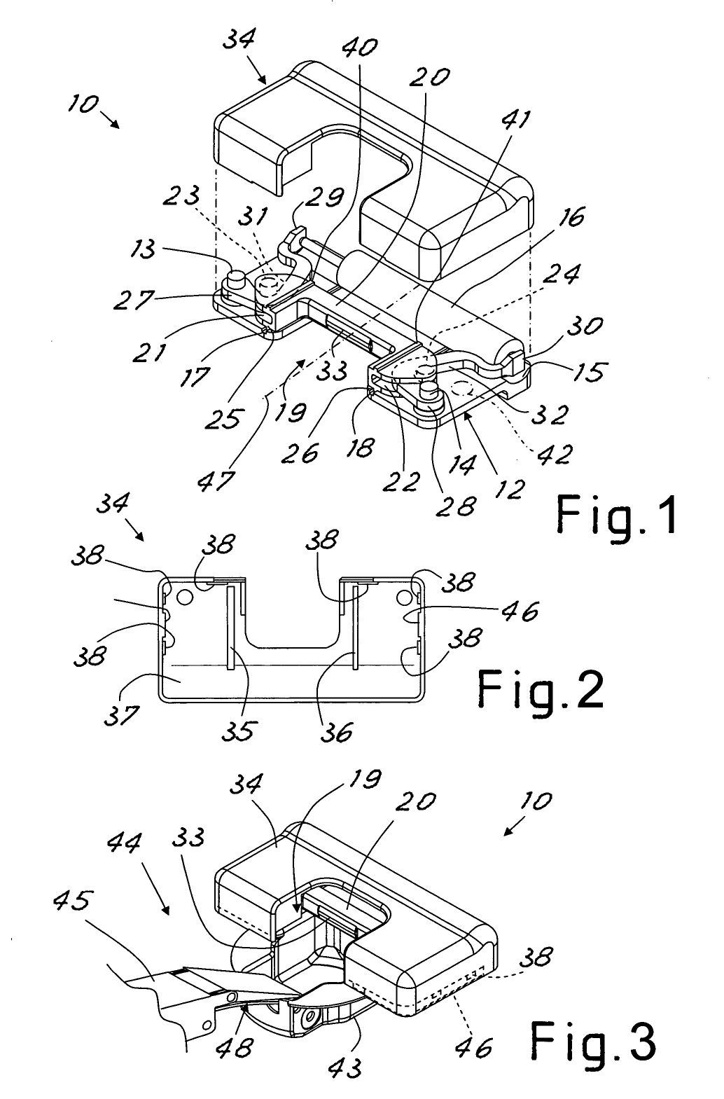

Referring to the figures, shown in FIG. 1 is an exploded view of a damping device group, indicated in its entirety by 10, made according to the invention.

The group 10 comprises a base element or plate 12 (advantageously substantially flat C-shaped) having a main axis 47 intended to substantially coincide with the extension axis of the hinge. Symmetrically with respect to the main axis, the plate bears on the two lateral zones two pins 13 and 14 with axis normal to the plate.

On the opposite side, provided in a transverse direction is a seat 15 for the sliding accommodation of a linear damping device 16 made according to the prior art and extending in a transverse manner with respect to the axis 47. Advantageously, the central zone of the base, on the side opposite to the seat 15, is open to form a slot 19 between the two pins 13 and 14 and the two slots 17 and 18.

Inserted on the two pins 13 and 14 with freedom to rotate are two elbow-shaped levers 27 and 28, identical and perfectly symmetrical, bearing—at one end—the pivoting seat and—at the opposite end—a zone 29, 30 for supporting an end of the damping device.

The central zone of each lever is shaped in such a manner to form a cam surface 31, 32, curved but parallel to the pivoting axis of the lever. The two levers are dimensioned in such a manner that, once inserted in the pins 13 and 14, the flat zones 29, 30 are located at the seat 15 in contact with the ends of the damping device 16.

Borne at the flat surface of the base 12 between the two levers is a slider 20, intended to slide according to the main axis 47 and projecting from the edge of the base plate with one of its actuation surfaces 33. The slider has sliding engagements, at the two sides at the levers, for sliding on the opposite tilted surfaces 31, 32 of the two levers.

The slider is advantageously substantially C-shaped and it is symmetric with respect to the main axis and, substantially, to two of the three median orthogonal planes.

In order to form the sliding engagements on the levers, the two opposite ends of the slider 20 are advantageously centrally engraved to form symmetric cavities 21 and 22 extended in the plane of the plate 12. Present inside each cavity are vertical cylinders 23 and 24 connecting the two lower and upper strips of each cavity 21, 22.

The two levers are inserted into the respective cavities 21 and 22 of the slider 20 in such a manner that the surfaces 31 and 32 are in contact with the cylinders 23 and 24, with the two surfaces 31, 32 forming a V-shape widening towards the damping device, with the cylinders 23 and 24 outside the V.

In this manner, by exerting a longitudinal force on the central part 33 of the slider 10, the latter moves rearwards on the plate, rotating in a symmetrical manner towards the internal of the two levers 27 and 28. The rotation of the two levers towards each other causes the ends 29, 30 to move closer and, thus, the compression the damping device 16.

By eliminating the thrust on the central part 33, the reset thrust of the damping device oppositely rotates the levers 27 and 28 and the latter in turn move the slider 20 back to its initial forward position. The surfaces 31, 32 can be shaped in such a manner to create an ideal relation position between the longitudinal movement of the slider 20 and the rotation of the levers and, thus, between the longitudinal movement of the slider 20 and the axial compression of the damping device 16.

Advantageously provided on the upper and lower surfaces of the slider are two pairs of identical and parallel prismatic guides 25, 26 and 40, 41. The lower prismatic guides are made in such a manner to be adapted with minimum clearance in the prismatic slots 17 and 18 of the base 12 parallel to the axis 47 in such a manner to allow a movement without rotating the slider 20 with respect to the base 12 along the axis 47.

The damping device group 10 is completed by a cover 34 which follows the contour of the base 12. As observable in FIG. 2, the cover advantageously bears two parallel prismatic holes 35 and 36 opposite to the slots 17 and 18 of the base 12 and a seat 37 which completes the seat 15 provided at the base 12 for accommodating the linear damping device 16. Accommodated in a sliding manner in the holes 35, 36 are the upper prismatic guides 40, 41 of the slider.

The cover is advantageously provided with a plurality of coupling engagement systems 38 which allow rigid fixing on the lateral walls of the base element 12. In this manner, the damping device group is formed to shape a closed box, as well observable in FIG. 3, with the thrust surface 33 of the slider located between the arms of the box-shaped C.

The damping device group 10 can be easily applied to any articulated hinge with a holding member of the prior art, for example by means of a snap-engagement system, easily imaginable by a man skilled in the art, according to the present invention. The edges of the cover 34 can be made suitably projecting beneath the base 12 (as observable from the dashed line in FIG. 3) in such a manner to allow a clip-engagement on the lateral flanges of a hinge holding member. The clips 46 are shown for example in FIG. 2.

Shown in FIG. 3 is the group 10 applied to the holding member 43 of an articulated hinge 44 of the prior art (not entirely shown being easily imaginable by a man skilled in the art), with a holding member 43 intended to be recessed into a door and a wing 45 intended for fixing onto the piece of furniture, present between the wing and holding member being articulated connection arms 48. The central part 19 of the C-shaped element is overlapped on the compartment in the holding member which is intended to accommodate the head part of the wing 45 when the hinge is moved to the closed condition.

Alongside the snap means, for fixing the group 10 also provided for can be holes 42 (schematically shown with a dashed line in FIG. 1) in the base coinciding with the fixing holes usually present on the lateral wings of the holding member which are covered by the device. The same screws fixing the holding member to the piece of furniture can thus fix the damping device group.

During the closure movement of the hinge, the front part of the wing penetrates into the holding member and pushes against the surface 33 of the slider, moving the slider 20 backwards and thus compressing the damping device 16 by means of the symmetric movement of the levers.

At this point it is clear how the preset objects are attained. Due to the group according to the invention, obtained is the desired effect of damping the closure of a door using an accessory easily fixable on the box of a standard hinge and having a minimum overall dimension both lateral and in depth with respect to the box itself. Substantially, the damping device group may reproduce the shape of the wings of the holding member. The kinematism used allows an ideal exploitation of the actuation travel of the linear damping device. Furthermore, the minimum number of parts makes the device reliable and inexpensive.

Obviously, the aforementioned description of an embodiment applying the innovative principles of the present invention is given as an example of such innovative principles and thus should not be deemed restrictive in the scope of the patent herein claimed. If required, for example it is possible to provide the base 12 directly integral with the holding member, in such a manner that the base 12 directly forms the fixing flanges of the holding member. The two levers can be of different shapes, for example with a suitably projecting cam surface instead of being elbow-shaped.

What is claimed is:

1. A damping device group intended to be mounted onto an articulated hinge for pieces of furniture, comprises:
a base plate, integral with or to be fixed onto flanges of the hinge holding member, shaped to have lateral zones intended to be arranged on the two sides of the holding member, with a main axis of the plate substantially coinciding with the extension axis of the hinge;
two levers each shaped and pivoted on one of said two lateral zones according to an axis normal to the plate, in such a manner to be extended parallel to the surface of the plate and perfectly symmetrical with respect to said main axis of the plate, the levers ending oppositely with respect to the pivoting with facing ends which operate on opposite ends of a linear travel damping device arranged in a transverse manner with respect to the main axis of the plate;
a slider mounted in a sliding manner on the plate between the two levers to project with one of its actuation surfaces from an edge of the plate arranged between said two lateral zones, the slider being extended in a transverse manner with respect to said main axis, being sliding according to the said main axis and having sliding engagements at the two sides at the levers to slide on opposite tilted surfaces of the two levers in such a manner to pull the levers towards each other and compress the damping device therewith when the slider is pushed towards the damping device.

2. Damping device group according to claim 1, characterized in that the plate is C-shaped with the lateral pivoting zones of the levers arranged on the arms of the C-shaped element and the actuation surface of the slider projecting in the empty central zone of the C-shaped element.

3. Damping device group according to claim 1, characterized in that—in order to form sliding engagements on the levers—present on each side of the slider is a cavity extended in the plane of the plate and provided with a respective vertical cylinder therein, the levers each being inserted into one of said cavities to lie with its surface on the respective cylinder.

4. Damping device group according to claim 3, characterized in that the levers are purposely bent to form an elbow-shape with said tilted surfaces forming a V-shape widening towards the damping device.

5. Damping device group according to claim 3, characterized in that the slider is C-shaped, with the actuation surface between the arms of the C-shaped element.

6. Damping device group according to claim 1, characterized in that present between the base and the slider are sliding guides extended parallel to the main axis.

7. Damping device group according to claim 1, characterized in that fixed above the base is a complementary cover.

8. Damping device group according to claim 7, characterized in that present between the cover and the slider are sliding guides extended parallel to the main axis.

9. Damping device group according to claim 7, characterized in that present between the cover and the base is a plurality of coupling engagement systems.

10. Damping device group according to claim 7, characterized in that the cover extends with at least part of its lower edge beyond the base plate to provide snap-coupling elements on a hinge holding member.

11. Articulated hinge for pieces of furniture, provided with a holding member intended to be recessed in a door leaf and a wing intended to be fixed onto the piece of furniture, present between the wing and the holding member being articulated connection arms, present on the holding member being a damping device group according to any one of the preceding claims to provide an actuation surface projecting above the compartment of the holding member and be pushed in actuation by the part of the wing penetrating into the compartment when the hinge is moved to a closed position.
